(19) United States
(12) Patent Application Publication
(10) Pub. No.: US 2014/0025269 A1
(43) Pub. Date: Jan. 23, 2014

(54) CONTROL DEVICE OF VEHICLE DRIVE DEVICE

(71) Applicants: Atsushi Ayabe, Toyota-shi (JP); Shinya Toyoda, Nisshin-shi (JP)

(72) Inventors: Atsushi Ayabe, Toyota-shi (JP); Shinya Toyoda, Nisshin-shi (JP)

(73) Assignee: TOYOTA JIDOSHA KABUSHIKI KAISHA, Toyota-shi, Aichi (JP)

(21) Appl. No.: 14/111,065

(22) PCT Filed: Apr. 12, 2011
(86) PCT No.: PCT/JP2011/059065

§ 371 Date: Oct. 10, 2013

(51) Int. Cl. F16D 25/12

(52) U.S. Cl. CPC F16D 25/12
USPC 701/60; 701/67; 701/68

(57) ABSTRACT

A control device of a vehicle drive device in which an output of a power source is input from a hydraulic power transmission device via a friction engagement device to a continuously variable transmission and transmitted toward drive wheels after speed is changed by the continuously variable transmission, the control device includes: an abnormality detecting portion configured to make a determination of abnormality indicating that the friction engagement device is in a complete release state or a slip state; and an abnormality distinguishing portion, if the abnormality detecting portion makes a determination of abnormality, configured to judge that the friction engagement device is in the slip state when an input/output rotation speed difference between an input rotation speed and an output rotation speed of the hydraulic power transmission device is equal to or greater than a predetermined slip determination value and that the friction engagement device is in the complete release state when the input/output rotation speed difference is less than the slip determination value.

### TECHNICAL FIELD

The present invention relates to a control device of a vehicle drive device and particularly to determination of abnormality of a friction engagement device disposed in a power transmission path.

### BACKGROUND ART

A vehicle drive device is known in which power source output is input from a hydraulic power transmission device via a friction engagement device to a continuously variable transmission and transmitted toward drive wheels after speed is changed by the continuously variable transmission. A device described in Patent Document 1 is an example thereof, and hydraulic clutches and brakes are used as the friction engagement devices such that forward running and backward running can be switched, while a belt type continuously variable transmission is employed as the continuously variable transmission. An input rotation speed and an output rotation speed of the belt type continuously variable transmission are detected and, based on the output rotation speed, i.e., vehicle speed, a target rotation speed related to the input rotation speed is set, and shift control of the belt type continuously variable transmission is provided such that the input rotation speed is set to the target rotation speed.

### PRIOR ART DOCUMENT

### Patent Document

Patent Document 1: Japanese Laid-Open Patent Publication No. 2005-114069

### SUMMARY OF THE INVENTION

### Problems to be Solved by the Invention

Although not known, it is conceivable that the input rotation speed of the friction engagement device is used for providing shift control of a continuously variable transmission on the premise of a complete engagement state of a friction engagement device for switching forward running and backward running etc. In this case, if the friction engagement device is slipped or released that should be in the complete engagement state, the shift control cannot properly be provided and durability is reduced and, for example, by comparing a target gear ratio of the continuously variable transmission with the input rotation speed of the friction engagement device, a determination of abnormality of the friction engagement device can be made and fail-safe can be implemented for the abnormality of the friction engagement device. However, since it cannot be distinguished whether the abnormality of the friction engagement device is due to a slip state or a complete release state, the fail-safe is difficult to properly implement, resulting in a problem of deterioration in limp-home capability due to excess fail-safe.

The present invention was conceived in view of the situations and it is therefore an object of the present invention to enable determination on whether abnormality is a complete release state or a slip state if a determination of abnormality is made to indicate that a friction engagement device is in the complete release state or the slip state in a vehicle drive device in which power source output is input from a hydraulic power transmission device via the friction engagement devices to a continuously variable transmission.

### Means for Solving the Problem

To achieve the object, the first aspect of the invention provides a control device of a vehicle drive device in which an output of a power source is input from a hydraulic power transmission device via a friction engagement device to a continuously variable transmission and transmitted toward drive wheels after speed is changed by the continuously variable transmission, the control device comprising: (a) an abnormality detecting means making a determination of abnormality indicating that the friction engagement device is in a complete release state or a slip state; and (b) an abnormality distinguishing means, if the abnormality detecting means makes a determination of abnormality, judging that the friction engagement device is in the slip state when an input/output rotation speed difference between an input rotation speed and an output rotation speed of the hydraulic power transmission device is equal to or greater than a predetermined slip determination value and that the friction engagement device is in the complete release state when the input/output rotation speed difference is less than the slip determination value.

The second aspect of the invention provides the control device of a vehicle drive device recited in the first aspect of the invention, comprising (a) a shift control means detecting an input rotation speed of the friction engagement device to provide shift control of the continuously variable transmission based on the input rotation speed and a predetermined target gear ratio on premise that the friction engagement device is in a complete engagement state is comprised, wherein (b) the abnormality detecting means makes the determination of abnormality based on the input rotation speed and the target gear ratio.

The third aspect of the invention provides the control device of a vehicle drive device recited in the second aspect of the invention, wherein (a) the continuously variable transmission is a belt type continuously variable transmission, wherein (b) the abnormality detecting means makes a determination of abnormality indicating that the friction engagement device is in a complete release state or a slip state or that the belt type continuously variable transmission is in a slip state, and wherein (c) the abnormality distinguishing means judges that the friction engagement device or the belt type continuously variable transmission is in the slip state if the input/output rotation speed difference of the hydraulic power transmission device is equal to or greater than the slip determination value.

The fourth aspect of the invention provides the control device of a vehicle drive device recited in the first to third aspects of the invention, wherein (a) the friction engagement device is a hydraulic friction engagement device engaged by oil pressure, wherein (b) the control device comprises a relay valve having a first supply position for supplying to the hydraulic friction engagement device a garage shift oil pressure adjusted by a hydraulic control valve and a second supply position for supplying to the hydraulic friction engagement device a high-low oil pressure controlled between two high and low stages depending on a transmission torque, wherein the relay valve is switched to the first supply position when the hydraulic friction engagement device is switched from a release state to an engagement state, wherein the relay valve is switched to the second supply position at the time of complete engagement of the hydraulic friction engagement device, wherein (c) the hydraulic friction engagement device enters the complete release state due to a failure in which the relay valve is switched to the first supply position at the time of complete engagement of the hydraulic friction engagement device, and wherein the hydraulic friction engagement device enters the slip state due to a failure in which the high-low oil pressure is put into a low pressure state at the time of high pressure.

The fifth aspect of the invention provides the control device of a vehicle drive device recited in the fourth aspect of the invention, wherein (a) if the abnormality distinguishing means judges that the friction engagement device is in the slip state, an input torque input to the hydraulic friction engagement device is reduced, and wherein (b) if the abnormality distinguishing means judges that the friction engagement device is in the complete release state, the relay valve is switched to the second supply position by an abnormal-time solenoid valve to completely engage the hydraulic friction engagement device by the high-low oil pressure.

### Effects of the Invention

In the control device of a vehicle drive device as described above, if the abnormality detecting means makes the determination of abnormality indicating that the friction engagement device is in the complete release state or the slip state, the abnormality distinguishing means distinguishes between the slip state and the complete release state depending on whether the input/output rotation speed difference of the hydraulic power transmission device is equal to or greater than the predetermined slip determination value. In particular, in the case of the slip state, the transmission torque through the slip affects an output-side rotation speed of the hydraulic power transmission device, making the input/output rotation speed difference larger; on the other hand, in the case of the complete release state, the input/output rotation speed difference of the hydraulic power transmission device is substantially zero; therefore, the friction engagement device can be distinguished between the slip state and the complete release state based on the input/output rotation speed difference. When the friction engagement device can be distinguished between the slip state and the complete release state as described above, the subsequent fail-safe can individually properly be implemented and the problem of the deterioration in limp-home capability due to excess fail-safe can be removed.

The second aspect of the invention is the case where the shift control of the continuously variable transmission is provided based on the input rotation speed and the predetermined target gear ratio on premise that the friction engagement device is in the complete engagement state, a rotation speed sensor detecting the input rotation speed itself of the continuously variable transmission is not necessarily needed and an inexpensive configuration is achieved. Also, if the slip state or the complete release state occurs in the friction engagement device that should be in the complete engagement state, the shift control of the continuously variable transmission based on the input rotation speed of the friction engagement device cannot properly be provided and, therefore, by comparing the input rotation speed of the friction engagement device with the target gear ratio of the continuously variable transmission, the determination of abnormality can be made to indicate that the friction engagement device is in the complete release state or the slip state.

The third aspect of the invention is the case where the continuously variable transmission is a belt type continuously variable transmission, the abnormality detecting means makes a determination of abnormality indicating that the friction engagement device is in the complete release state or the slip state or that the belt type continuously variable transmission is in the slip state (belt slip), and the abnormality distinguishing means judges that the friction engagement device or the belt type continuously variable transmission is in the slip state if the input/output rotation speed difference of the hydraulic power transmission device is equal to or greater than the slip determination value. In other words, if the determination of abnormality is made based on the input rotation speed of the friction engagement device and the target gear ratio as described in the second aspect of the invention, a changing trend of the input rotation speed of the friction engagement device is the same regardless of whether the slip state of the friction engagement device or the slip state of the belt type continuously variable transmission and, therefore, not only the complete release state and the slip state of the friction engagement device but also the slip state of the belt type continuously variable transmission can be distinguished at the same time.

The fourth aspect of the invention is the case where the friction engagement device is a hydraulic friction engagement device, the relay valve being switched to the first supply position for supplying to the hydraulic friction engagement device the garage shift oil pressure when the hydraulic friction engagement device is switched from the release state to the engagement state and being switched to the second supply position for supplying to the hydraulic friction engagement device the high-low oil pressure at the time of complete engagement of the hydraulic friction engagement device is comprised, the hydraulic friction engagement device enters the complete release state due to the failure in which the relay valve is switched to the first supply position at the time of complete engagement of the hydraulic friction engagement device, and the hydraulic friction engagement device enters the slip state due to the failure in which the high-low oil pressure is put into the low pressure state at the time of high pressure. In other words, the hydraulic control circuit as described above may cause the failure of the hydraulic friction engagement device switched to the complete release state or the slip state due to a malfunction of a switching valve for switching a supply position of the relay valve etc; however, by providing with the abnormality detecting means and the abnormality distinguishing means, it can be properly distinguished whether the hydraulic friction engagement device is in the complete release state or the slip state.

With regard to the fifth aspect of the invention, if the abnormality distinguishing means judges that the friction engagement device is in the slip state, the input torque input to the hydraulic friction engagement device is reduced in the fourth aspect of the invention and, therefore, the slip of the hydraulic friction engagement device is suppressed to ensure durability while the slip when the belt type continuously variable transmission used as a continuously variable transmission is in the slip state is also suppressed. If it is judged that the friction engagement device is in the complete release state, the relay valve is switched to the second supply position by the abnormal-time solenoid valve to completely engage the hydraulic friction engagement device by the high-low oil pressure, thereby enabling the vehicle to run and perform the limp-home operation.

### BRIEF DESCRIPTION OF THE DRAWINGS

FIG. 1 is a schematic for explaining a vehicle drive device to which the present invention is applied.

FIG. 2 is a block diagram for explaining a main portion of a control system disposed in the vehicle drive device of FIG. 1.

FIG. 3 is a hydraulic circuit diagram for specifically explaining portions in relation to the forward clutch and the backward brake in the hydraulic control circuit of FIG. 2.

FIG. 4 is a functionally block diagram for explaining a main portion of functions included in the electronic control device of FIG. 2 in relation to the shift control including the forward and backward switching.

FIG. 5 is a diagram for explaining an example of a shift map used when a target rotation speed Nint is obtained in the shift control of the belt type continuously variable transmission.

FIG. 6 is a flowchart for specifically explaining processes provided by the abnormality detecting means, the abnormality distinguishing means, and the fail-safe means of FIG. 4.

FIG. 7 are an example of respective time charts of the rotation speeds of the portions and the gear ratios when the forward clutch that should be in the complete engagement state is in the complete release state or the slip state.

### MODE FOR CARRYING OUT THE INVENTION

A power source is an engine such as an internal combustion engine generating power through combustion of fuel or an electric motor, and a torque converter or a fluid coupling is preferably used for a hydraulic power transmission device. A single-plate or multiplate hydraulic clutch or brake frictionally engaged by oil pressure is preferably used as a friction engagement device. For a continuously variable transmission, for example, a belt-type continuously variable transmission having a transmission belt wrapped around a pair of variable pulleys is widely used; however, other continuously variable transmissions such as those of the toroidal type are also employable.

A shift control means controlling a gear ratio γ (=input rotation speed Nin of continuously variable transmission/output rotation speed Nout of continuously variable transmission) of the continuously variable transmission is configured to calculate a target rotation speed Nint in accordance with a shift condition such as a shift map defined by using a driver's output request amount such as an accelerator operation amount and a vehicle speed as parameters, for example, and to provide shift control such that the input rotation speed Nin is set to the target rotation speed Nint. Since the gear ratio γ is [input rotation speed Nin/output rotation speed Nout] and the output rotation speed Nout is determined depending on the vehicle speed and is constant on a short period basis, the gear ratio γ can be controlled by controlling the input rotation speed Nin. If the gear ratio γ itself is calculated in accordance with the shift condition such as the shift map and the input rotation speed Nin is controlled to achieve the gear ratio γ, the same result is acquired. In the second aspect of the invention, an input rotation speed NFin of the friction engagement device is used instead of the input rotation speed Nin on the premise that a friction engagement device is in the complete engagement state. If the friction engagement device is a backward brake and the input rotation speed NFin of the friction engagement device does not coincide with an output rotation speed NFout, the input rotation speed NFin of the friction engagement device may be converted into the input rotation speed Nin of the continuously variable transmission (=NFout) in accordance with a conversion equation defined based on a gear ratio etc., of a reversing mechanism such as a planetary gear device. In the case of a belt type continuously variable transmission, the gear ratio γ can be controlled through a thrust force ratio of a primary side variable pulley and a secondary side variable pulley.

In the second aspect of the invention, based on the input rotation speed NFin of the friction engagement device and a target gear ratio γt (corresponding to the target rotation speed Nint), for example, in the case of a forward clutch, if a difference ΔN between the input rotation speed NFin and the target rotation speed Nint (=NFin-Nint) becomes equal to or greater than a predetermined abnormality determination value ΔNs, a determination of abnormality is made to indicate that the friction engagement device is in a complete release state or a slip state. In the case of the backward brake, the input rotation speed NFin can be converted into the input rotation speed Nin to make the determination of abnormality in the same way. In the first aspect of the invention, for example, both the input rotation speed NFin and the output rotation speed NFout of the friction engagement device are detected and, in the case of the forward clutch, the determination of abnormality in the friction engagement device can be made depending on whether a rotation speed difference ΔNF therebetween (=NFin-NFout) becomes equal to or greater than a predetermined abnormality determination value ΔNFs. In the case of the backward brake, the determination of abnormality can be made by comparing a rotation speed ratio of the input rotation speed NFin and the output rotation speed NFout with the gear ratio of the reversing mechanism such as a planetary gear device. The abnormality determination values ΔNs and ΔNFs may be constant values or may be defined by using a vehicle state such as the target gear ratio γt as a parameter. Since the differences ΔN and ΔNF are negative during power source brake running, the absolute values of the differences ΔN and ΔNF may be used or different determination values may be defined for positive and negative values.

With regard to an abnormality distinguishing means judging that the friction engagement device is in a slip state when an input/output rotation speed difference of a hydraulic power transmission device is equal to or greater than a predetermined slip determination value, since the positive and negative of the input/output rotation speed difference of the hydraulic power transmission device are reversed between a drive running and a power source brake running, the absolute value of the input/output rotation speed difference may be used or different slip determination values may be defined for positive and negative values. The slip determination value may be a constant value or may be defined by using a vehicle state such as a power source rotation speed as a parameter.

In the second aspect of the invention, the shift control of the continuously variable transmission is provided based on the input rotation speed NFin and a predefined target gear ratio γt on the premise that the friction engagement device is in the complete engagement state and, therefore, a rotation speed sensor detecting the input rotation speed Nin itself of the continuously variable transmission is not necessarily required; however, the rotation speed sensor detecting the input rotation speed Nin of the belt type continuously variable transmission can be disposed as needed. When the first aspect of the invention is implemented, the shift control of the continuously variable transmission may be provided based on the input rotation speed Nin of the belt type continuously variable transmission and the target gear ratio γt.

In the third aspect of the present invention having the belt type continuously variable transmission as the continuously variable transmission, it can only be judged that the friction engagement device or the belt type continuously variable transmission is in the slip state when the input/output rotation speed difference of the hydraulic power transmission device is equal to or greater than the slip determination value and it cannot be distinguished whether the friction engagement device is in the slip state or the belt type continuously variable transmission is in the slip state; however, if needed, the input rotation speed Nin of the belt type continuously variable transmission can be detected and the input rotation speed Nin can be compared with the input rotation speed NFin of the friction engagement device to distinguish whether the friction engagement device is in the slip state or the belt type continuously variable transmission is in the slip state.

The hydraulic control circuit of the fourth aspect of the invention is merely an example and when another aspect of the invention is implemented, the hydraulic control circuit may be applied to various hydraulic control circuits generating a failure causing the friction engagement device disposed between the hydraulic power transmission device and the continuously variable transmission to enter the complete release state and the slip state when the friction engagement device should be in the complete engagement state. With regard to the hydraulic control circuit of the fourth aspect of the invention, if it is judged that the friction engagement device is in the slip state, the input torque input to the hydraulic friction engagement device is reduced in the fifth aspect of the invention, and this may be achieved by limiting the output of the power source, for example. Besides reducing the input torque, for example, a line oil pressure PL used as an original pressure of a high-low oil pressure can be increased to raise the level of the high-low oil pressure, or a relay valve can be switched to a first supply position by an abnormal-time solenoid valve to supply a garage shift oil pressure to a hydraulic friction engagement device while controlling the garage shift oil pressure with an hydraulic control valve so as to suppress a slip of the hydraulic friction engagement device and, therefore, various fail-safe means can be employed depending on the hydraulic control circuit.

In the fifth aspect of the invention, if the abnormality distinguishing means judges that the friction engagement device is in the complete release state, the relay valve is switched to a second supply position by the abnormal-time solenoid valve to completely engage the hydraulic friction engagement device by the high-low oil pressure; however, for example, while a failure of the relay valve set to the first supply position is maintained, the garage shift oil pressure can be controlled with the hydraulic control valve so as to completely engage the hydraulic friction engagement device and, therefore, various fail-safe means can be employed depending on the hydraulic control circuit. Although the abnormal-time solenoid valve may be a solenoid valve used only during abnormal time of the friction engagement device, an existing solenoid valve disposed for another purpose can also be utilized.

### EXAMPLE

An example of the present invention will now be described in detail with reference to the drawings.

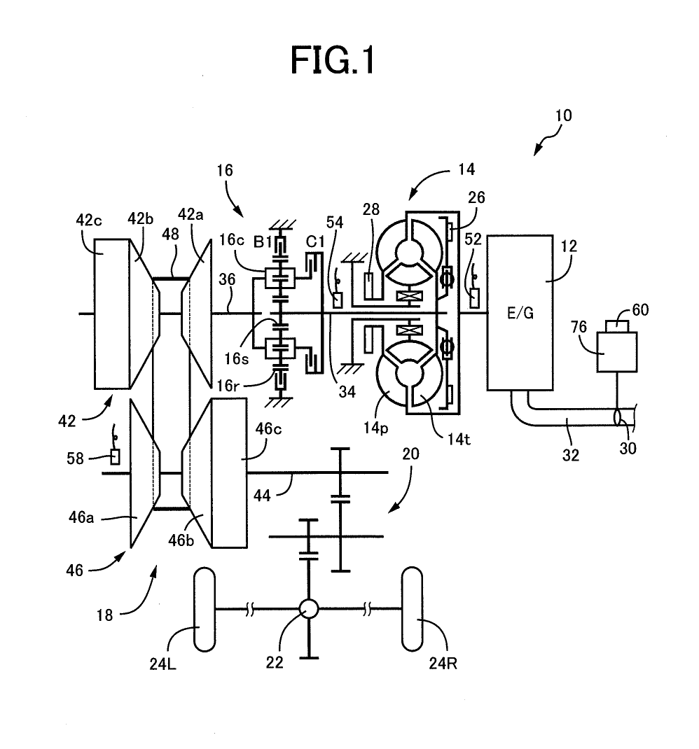

FIG. 1 is a schematic for explaining a configuration of a vehicle drive device 10 to which the present invention is applied. The vehicle drive device 10 is preferably employed in FF (front-engine front-drive) type vehicles and includes an engine 12 as a power source for running. The engine 12 is an internal combustion engine generating power through combustion of fuel and the output of the engine 12 is transmitted from a torque converter 14 acting as a hydraulic power transmission device through a forward/backward switching device 16, a belt type continuously variable transmission (CVT) 18, and a reduction gear device 20 to a differential gear device 22 to be distributed to left and right drive wheels 24L and 24R.

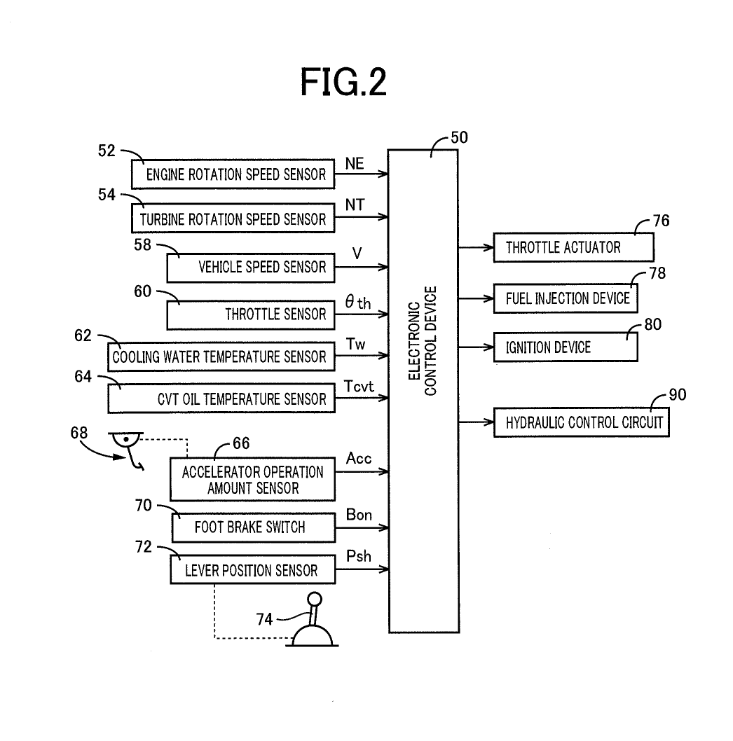

The torque converter 14 includes a pump impeller 14p coupled to a crankshaft of the engine 12 and a turbine impeller 14t coupled via a turbine shaft 34 to the forward/backward switching device 16 so as to transmit power through fluid. A lockup clutch 26 is disposed between the pump impeller 14p and the turbine impeller 14t and is engaged or released when oil pressure supply to an engagement side oil chamber and a release side oil chamber is switched by a lockup control valve etc., in a hydraulic control circuit 90 (see FIG. 2). To the pump impeller 14p, a mechanical oil pump 28 is coupled that generates oil pressure for providing shift control of the belt type continuously variable transmission 18, generating a belt pinching force, providing engagement/release control of the lockup clutch 26, or supplying lubricant oil to portions.

The forward/backward switching device 16 is mainly made up of a double pinion type planetary gear device with the turbine shaft 34 of the torque converter 14 integrally coupled to a sun gear 16s and with an input shaft 36 of the belt type continuously variable transmission 18 integrally coupled to a carrier 16c while the carrier 16c and the sun gear 16s are selectively coupled via a forward clutch C1, and a ring gear 16r is selectively fixed to a housing via a backward brake B1. The forward clutch C1 and the backward brake B1 correspond to a connecting/interrupting device connecting/interrupting power transmission and both are multiplate hydraulic friction engagement devices frictionally engaged by hydraulic cylinders.

When the forward clutch C1 is engaged and the backward brake B1 is released, the forward/backward switching device 16 is put into an integrally rotating state and the turbine shaft 34 is directly coupled to the input shaft 36 to establish (achieve) a forward power transmission path, thereby transmitting the forward direction drive power toward the belt type continuously variable transmission 18. When the backward brake B1 is engaged and the forward clutch C1 is released, a backward power transmission path is established (achieved) and the input shaft 36 is rotated in the backward direction relative to the turbine shaft 34, thereby transmitting the backward direction drive power toward the belt type continuously variable transmission 18. When both the forward clutch C1 and the backward brake B1 are released, the forward/reverse switching device 16 is put into neutral (interrupted state) in which the power transmission is interrupted.

The belt type continuously variable transmission 18 includes a primary variable pulley 42 that is an input-side member disposed on the input shaft 36 and that has a variable effective diameter, i.e., a variable groove width, a secondary variable pulley 46 that is an output-side member disposed on an output shaft 44 and that has a variable effective diameter, i.e., a variable groove width, and a transmission belt 48 wrapped around the variable pulleys 42 and 46, and the power is transmitted through a frictional force between the variable pulleys 42, 46 and the transmission belt 48.

A pair of the variable pulleys 42 and 46 include an input-side fixed rotating body 42a and an output-side fixed rotating body 46a fixed to the input shaft 36 and the output shaft 44, respectively, an input-side movable rotating body 42b and an output-side movable rotating body 46b disposed relatively non-rotatably around the axis and movably in the axial direction relative to the input shaft 36 and the output shaft 44, and an input-side hydraulic cylinder 42c and an output-side hydraulic cylinder 46c as hydraulic actuators applying thrust forces for changing V-groove widths therebetween. A primary oil pressure PIN supplied to the input-side hydraulic cylinder 42c is controlled by the hydraulic control circuit 90 to vary the V-groove widths of the both variable pulleys 42 and 46, thereby changing a wrapping diameter (effective diameter) of the transmission belt 48 and continuously varying the gear ratio γ (=input rotation speed Nin/output rotation speed Nout). The input rotation speed Nin is rotation speed of the input shaft 36 and the output rotation speed Nout is rotation speed of the output shaft 44. An oil pressure (secondary oil pressure Pd) of the output-side hydraulic cylinder 46c is adjusted and controlled by the hydraulic control circuit 90 to control the belt pinching force so as not to cause a slip of the transmission belt 48.

FIG. 2 is a block diagram for explaining a main portion of a control system disposed in the vehicle drive device 10 of FIG. 1. An electronic control device 50 includes a so-called microcomputer having a CPU, a RAM, a ROM, an I/O interface, etc., and the CPU executes signal processes in accordance with programs stored in advance in the ROM, while utilizing a temporary storage function of the RAM, to provide an output control of the engine 12, a shift control and the belt pinching force control of the belt type continuously variable transmission 18, a torque capacity control of the lockup clutch 26, etc., and is configured separately for an engine control, the hydraulic control of the belt type continuously variable transmission 18 and the lockup clutch 26, etc., as needed.

The electronic control device 50 is supplied with a signal indicative of a rotation speed (engine rotation speed) NE of the engine 12 detected by an engine rotation speed sensor 52; a signal indicative of a rotation speed (turbine rotation speed) NT of the turbine shaft 34 detected by a turbine rotation speed sensor 54; a signal indicative of an output rotation speed (rotation speed of the output shaft 44) Nout of the belt type continuously variable transmission 18, i.e., a rotation speed corresponding to a vehicle speed V, detected by a vehicle speed sensor 58; a throttle valve opening degree signal indicative of a throttle valve opening degree θth of an electronic throttle valve 30 included in an intake pipe 32 (see FIG. 1) of the engine 12 detected by a throttle sensor 60; a signal indicative of a cooling water temperature Tw of the engine 12 detected by a cooling water temperature sensor 62; a signal indicative of an operating oil temperature (oil temperature) Tcvt of the belt type continuously variable transmission 18 etc., detected by a CVT oil temperature sensor 64; an accelerator operation amount signal indicative of an accelerator operation amount Acc that is an operation amount of an accelerator pedal 68 detected by an accelerator operation amount sensor 66; a brake operation signal indicative of the presence of operation Bon of a foot brake that is a regular brake detected by a foot brake switch 70; an operation position signal indicative of a lever position (operation position) Psh of a shift lever 74 detected by a lever position sensor 72, etc. The engine rotation speed NE corresponds to an input-side rotation speed of the torque converter 14, and the turbine rotation speed NT is an output-side rotation speed of the torque converter 14 and corresponds to the input rotation speed NFin of the forward clutch C1 and backward brake B1.

The shift lever 74 is disposed near a driver's seat, for example, and is manually operated to one of four lever positions “P”, “R”, “N”, and “D” disposed in order. The “P” position is a parking position (position) for achieving a neutral state (neutral state) in which the power transmission of the vehicle drive device 10 is interrupted and for mechanically preventing (locking) the rotation of the output shaft 44 by a mechanical parking mechanism; the “R” position is a backward running position (position) for reversing the rotation direction of the output shaft 44; the “N” position is a neutral position (position) for achieving the neutral state in which the power transmission of the vehicle drive device 10 is interrupted; and the “D” position is a forward running position (position) for establishing an automatic shift mode in which forward running is performed while the belt type continuously variable transmission 18 is automatically shifted.

On the other hand, for the output control of the engine 12, the electronic control device 50 outputs, for example, a throttle signal for driving a throttle actuator 76 for controlling opening/closing of the electronic throttle valve 30, an injection signal for controlling the amount of fuel injected from a fuel injection device 78, and an ignition timing signal for controlling the timing of ignition of the engine 12 by an ignition device 80. By switching oil passages and controlling oil pressure by a solenoid valve and a linear solenoid valve disposed on the hydraulic control circuit 90, the primary oil pressure PIN related to the gear ratio γ of the belt type continuously variable transmission 18 is controlled while the secondary oil pressure Pd related to the belt pinching force is controlled, and the lockup control valve is controlled to provide the engagement/release control of the lockup clutch 26.

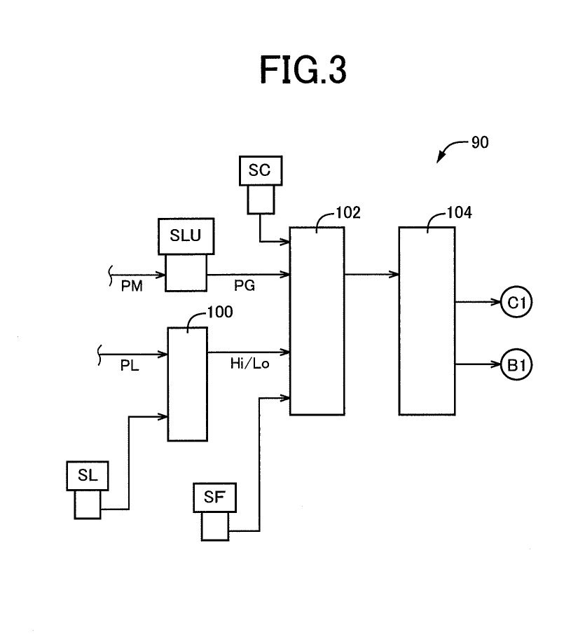

The hydraulic control circuit 90 further includes a circuit depicted in FIG. 3 in relation to the engagement/release control of the forward clutch C1 and the backward brake B1 of the forward/backward switching device 16. In FIG. 3, a high/low control valve 100 uses a switching oil pressure output from a solenoid valve SL to switch the line oil pressure PL to two types of oil pressure, i.e., a high pressure Hi and a low pressure Lo, for output, and a high-low oil pressure Hi/Lo at the high pressure Hi or the low pressure Lo is supplied to a relay valve 102. The high-low oil pressure Hi/Lo is for the purpose of maintaining the forward clutch C1 or the backward brake B1 in the complete engagement state and, in the solenoid valve SL, the output of the switching oil pressure is controlled in accordance with a drive signal supplied from the electronic control device 50 such that the high pressure Hi and the low pressure Lo are switched depending on a transmission torque of the forward clutch C1 or the backward brake B1, for example, the throttle valve opening degree θth. The relay valve 102 is also supplied with a garage shift oil pressure PG acquired by adjusting a modulator oil pressure PM with a linear solenoid valve SLU. The garage shift oil pressure PG is used for engaging the forward clutch C1 or the backward brake B1 when the shift lever 74 is operated from N to D, N to R, or P to R, and the oil pressure is continuously controlled by the linear solenoid valve SLU so as to suppress a shift shock. The linear solenoid valve SLU is a hydraulic control valve adjusting the garage shift oil pressure PG

The relay valve 102 is switched by a switching oil pressure output from a solenoid valve SC to a first supply position for outputting the garage shift oil pressure PG and a second supply position for outputting the high-low oil pressure Hi/Lo. The solenoid valve SC corresponds to a switching valve and switches the relay valve 102 from the second supply position to the first supply position to output the garage shift oil pressure PG when the operation of the shift lever 74 from N to D, N to R, or P to R is detected and, in the other cases, the output of the switching oil pressure is controlled depending on the drive signal supplied from the electronic control device 50 such that the relay valve 102 is retained at the second supply position to output the high-low oil pressure Hi/Lo. A manual valve 104 is disposed between the relay valve 102 and the forward clutch C1/the backward brake B1 and the manual valve 104 is mechanically or electrically switched depending on the operation position Psh of the shift lever 74 to supply an output oil pressure of the relay valve 102 to the forward clutch C1 in the case of operation to the “D” position and to supply the output oil pressure of the relay valve 102 to the backward brake B1 in the case of operation to the “R” position.

In the hydraulic control circuit 90 as described above, during the forward running or the backward running while the forward clutch C1 or the backward brake B1 should completely be engaged, if the relay valve 102 is switched to the first supply position due to, for example, a malfunction of the solenoid valve SC, the garage shift oil pressure PG is supplied to the forward clutch C1 or the backward brake B1 and, since the garage shift oil pressure PG is normally zero, the forward clutch C1 or the backward brake B1 is put into the complete release state interrupting the power transmission, and the vehicle becomes unable to run. An abnormal-time solenoid valve SF is disposed for a countermeasure against this failure and when a switching oil pressure output from the abnormal-time solenoid valve SF is supplied to the relay valve 102, the relay valve 102 can be switched to the second supply position even at the time of malfunction of the solenoid valve SC, and the clutch C1 or the brake B1 is completely engaged by the high-low oil pressure Hi/Lo, enabling the limp-home operation. For example, if the linear solenoid valve SLU can adjust the garage shift oil pressure PG, the linear solenoid valve SLU may control the garage shift oil pressure PG to completely engage the forward clutch C1 or the backward brake B1 while maintaining the failure of the relay valve 102 switched to the first supply position.

When the forward clutch C1 or the backward brake B1 is supplied with and completely engaged by the high pressure Hi as the high-low oil pressure Hi/Lo during the forward running or the backward running, if the high/low control valve 100 is switched to the state of outputting the low pressure Lo due to a malfunction of the solenoid valve SL, the forward clutch C1 or the backward brake B1 may run short of the engagement torque and enter the slip state. For a countermeasure against this failure, it is only necessary to reduce the input torque input to the forward clutch C1 or the backward brake B1 and, for example, the output of the engine 12 can be limited to achieve suppression of a slip (including complete engagement). If possible, it is also conceivable that the line oil pressure PL used as the original pressure of the high-low oil pressure Hi/Lo is increased to raise the level of the high-low oil pressure Hi/Lo or the relay valve 102 is switched by the abnormal-time solenoid valve SF to the first supply position to supply the garage shift oil pressure PG to the forward clutch C1 or the backward brake B1 while controlling the garage shift oil pressure PG with the linear solenoid valve SLU to suppress the slip of the forward clutch C1 or the backward brake B1.

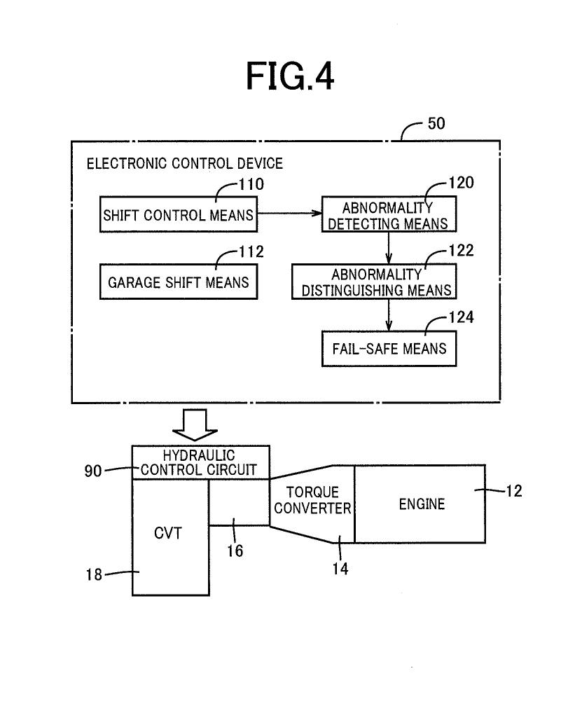

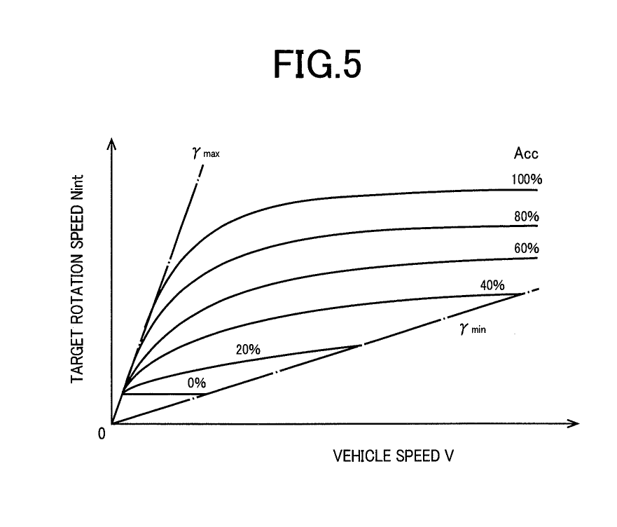

On the other hand, the electronic control device 50 functionally includes a shift control means 110 and a garage shift means 112 as depicted in FIG. 4 in relation to the shift control of the belt type continuously variable transmission 18 and the engagement/release control of the forward clutch C1 or the backward brake B1. During a forward running automatic transmission mode with the shift lever 74 operated to the “D” position, the shift control means 110 obtains the target rotation speed Nint of the input rotation speed Nin of the belt type continuously variable transmission 18 from a preset shift map using the accelerator operation amount Acc and the vehicle speed V as parameters as depicted in FIG. 5, for example, and controls the primary oil pressure PIN such that the actual input rotation speed Nin coincides with the target rotation speed Nint by providing feedback control of a shift-control linear solenoid valve etc. Since no sensor is included for detecting the input rotation speed Nin of the belt type continuously variable transmission 18 in this example, the shift control of the belt type continuously variable transmission 18 is provided such that the turbine rotation speed NT corresponding to the input rotation speed NFin of the forward clutch C1 coincides with the target rotation speed Nint on the premise that the forward clutch C1 is in the complete engagement state. Hereinafter, a gear ratio acquired by dividing the turbine rotation speed NT by the output rotation speed Nout is denoted by γf. If the forward clutch C1 is completely engaged, the gear ratio γf coincides with the actual gear ratio γ of the belt type continuously variable transmission 18.

Since the gear ratio γ is [input rotation speed Nin/output rotation speed Nout] and the output rotation speed Nout corresponds to the vehicle speed V and is constant on a short time basis, the target rotation speed Nint corresponds to the target gear ratio γt based on the current vehicle speed V and, when the control is provided such that the turbine rotation speed NT coincides with the target rotation speed Nint, the gear ratios y and γf are controlled to be substantially identical to the target shift ratio γt. The shift map of FIG. 5 is defined such that when the accelerator operation amount Acc, i.e., a driver's output request amount is smaller or when the vehicle speed V is higher, a proportion of the target rotation speed Nint to the vehicle speed V is smaller and the target gear ratio γt becomes smaller. During the backward running while the backward brake B1 is completely engaged, the shift control of the belt type continuously variable transmission 18 is provided based on the turbine rotation speed NT and the target rotation speed Nint and, in this case, the turbine rotation speed NT may be converted into the input rotation speed Nin of the belt type continuously variable transmission 18 by the gear ratio of the forward/backward switching device 16 to coincide with the target rotation speed Nint.

When the operation of the shift lever 74 from N to D, N to R, or P to R is detected, the garage shift means 112 causes the solenoid valve SC to switch the relay valve 102 from the second supply position to the first supply position so that the garage shift oil pressure PG is output. The garage shift means 112 causes the linear solenoid valve SLU to adjust the garage shift oil pressure PG in accordance with a predetermined change pattern, thereby suppressing the shift shock when the forward clutch C1 or the backward brake B1 is engaged. At a time other than when the shift lever 74 is operated from N to D, N to R, or P to R, the relay valve 102 is retained at the second supply position and the high-low oil pressure Hi/Lo is output so that the forward clutch C1 is completely engaged by the high-low oil pressure Hi/Lo during the forward running in the case of operation of the “D” position and that the backward brake B1 is completely engaged by the high-low oil pressure Hi/Lo during the backward running in the case of operation of the “R” position.

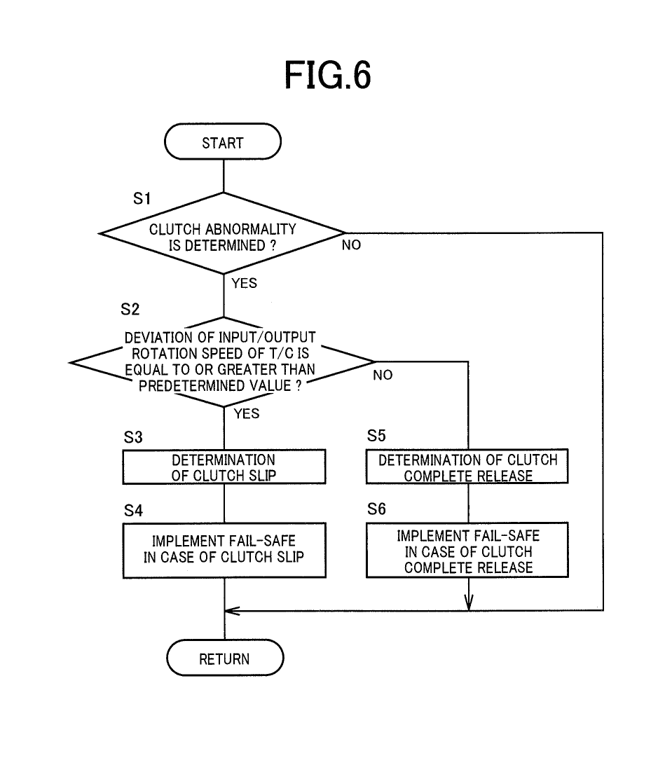

Returning to FIG. 4, the electronic control device 50 also functionally includes an abnormality detecting means 120, an abnormality distinguishing means 122, and a fail-safe means 124 and executes a signal process in accordance with a flowchart of FIG. 6 to detect a failure such as a slip state or a complete release state when the forward clutch C1 or the backward brake B1 should be in the complete engagement state or a slip state (belt slip) of the belt type continuously variable transmission 18, and to implement predetermined fail-safe. Step S1 of FIG. 6 corresponds to the abnormality detecting means 120; steps S2, S3, and S5 correspond to the abnormality distinguishing means 122; and the steps S4 and S6 correspond to the fail-safe means 124.

At step S1 of FIG. 6, during the forward running when the shift lever 74 is operated to the “D” position or during the backward running when operated to the “R” position, a determination of abnormality is made in terms of the slip state or the complete release state of the forward clutch C1 or the backward brake B1 that should be in the complete engagement state or the slip state of the belt type continuously variable transmission 18. Specifically, for example, in the case of the forward drive running, the shift control of the belt type continuously variable transmission 18 is provided in this example such that the turbine rotation speed NT coincides with the target rotation speed Nint on the premise that the forward clutch C1 is in the complete engagement state and, if the forward clutch C1 or the belt type continuously variable transmission 18 enters the slip state or the forward clutch C1 enters the complete release state, the turbine rotation speed NT deviates from the target rotation speed Nint regardless of the shift control and, therefore, the determination of abnormality can be made depending on whether a difference ΔN thereof (=NT-Nint) becomes equal to or greater than a predetermined abnormality determination value ΔNs. The abnormality determination value ΔNs may be a constant value or may be defined by using a vehicle state such as the target rotation speed Nint and the target gear ratio γt as a parameter. During shift transition of the belt type continuously variable transmission 18, the difference ΔN becomes larger even in the normal time without a slip etc., and therefore, the abnormality determination value ΔNs can be switched depending on whether during the shift transition or not. During driven running using an engine brake, the difference ΔN is negative and, therefore, the absolute value of the difference ΔN may be used or different determination values may be defined for positive and negative values. During the backward running while the backward brake B1 is completely engaged, the turbine rotation speed NT can be converted into the input rotation speed Nin to make the determination of abnormality as described above.

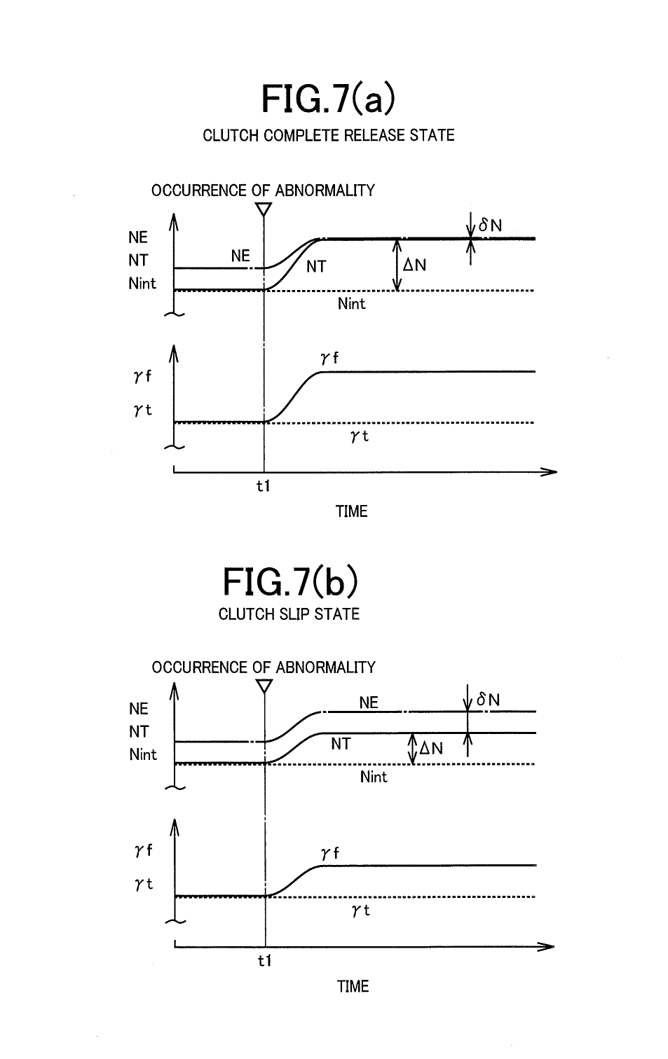

FIG. 7(a) is an example of a time chart of the rotation speeds NE, NT, and Nint of the portions and the gear ratios γf and γt when a failure occurs that is the complete release state of the forward clutch C1 during the forward drive running, and the complete release of the forward clutch C1 increases the turbine rotation speed NT greater than the target rotation speed Nint, generating a predetermined difference ΔN (=NT-Nint) between the turbine rotation speed NT and the target rotation speed Nint. FIG. 7(b) is an example of a time chart of the rotation speeds NE, NT, and Nint of the portions and the gear ratios γf and γt when a failure occurs that is the slip state of the forward clutch C1 or the belt type continuously variable transmission 18 during the forward drive running, and a slip of the forward clutch C1 or the belt type continuously variable transmission 18 increases the turbine rotation speed NT greater than the target rotation speed Nint, generating the predetermined difference ΔN (=NT-Nint) between the turbine rotation speed NT and the target rotation speed Nint. In this case, the increase in the turbine rotation speed NT is restricted by a transmission torque through a slip of the forward clutch C1 or the belt type continuously variable transmission 18 and, therefore, the difference ΔN is smaller as compared to the case of the complete release of (a). If the turbine rotation speed NT deviates from the target rotation speed Nint in this way, the gear ratio γf (=NT/Nout) deviates from the target gear ratio γt and, therefore, the determination of abnormality can also be made by comparing the gear ratio γf with the target gear ratio γt. Time t1 is an abnormality occurrence time in both FIGS. 7(a) and 7(b).

If the judgment at step S1 is YES (affirmative), i.e., if the determination of abnormality such as the slip and the complete release is made, step S2 is executed to distinguish between a slip failure that is the slip state of the forward clutch C1, the backward brake B1, or the belt type continuously variable transmission 18 and a complete release failure that is the complete release state of the forward clutch C1 or the backward brake B1, based on the deviation of the input/output rotation speed of the torque converter 14. In particular, in the case of the slip failure, the transmission torque through the slip affects the turbine rotation speed NT that is the output-side rotation speed of the torque converter 14, making an input/output rotation speed difference δN (=NE-NT) larger if the drive running is performed; on the other hand, in the case of the complete release state, the load of the turbine rotation speed NT is substantially zero, making the input/output rotation speed difference δN substantially zero; therefore, if the input/output rotation speed difference δN is equal to or greater than a predetermined slip determination value δNs, it can be judged that the slip failure occurs; in the case of δN<δNs, it can be judged that the complete release failure occurs. The slip determination value δNs may be a constant value or may be defined by using a vehicle state such as the engine rotation speed NE and the throttle valve opening degree θth as a parameter. During the driven running using an engine brake, the input/output rotation speed difference ιN is negative and, therefore, the absolute value of the input/output rotation speed difference δN may be used or different determination values may be defined for positive and negative values.

In the time chart of FIG. 7(a) in the case of occurrence of the complete release failure that is the complete release state of the forward clutch C1 during the forward drive running, since the load of the turbine rotation speed NT after the occurrence of abnormality is substantially zero, NE≈NT is satisfied, resulting in the input/output rotation speed difference δN (=NE−NT)≈0. On the other hand, in the time chart of FIG. 7(b) in the case of occurrence of the slip failure that is the slip state of the forward clutch C1 or the belt type continuously variable transmission 18, since the increase in the turbine rotation speed NT is restricted by the transmission torque through a slip of the forward clutch C1 or the belt type continuously variable transmission 18, the turbine rotation speed NT is lower as compared to the case of the complete release of (a) and a predetermined input/output rotation speed difference δN (=NE−NT) remains.

If the judgment at step S2 is YES, i.e., if the input/output rotation speed difference δN is equal to or greater than the slip determination value δNs, it is determined at step S3 that the slip failure occurs in which the forward clutch C1, the backward brake B1, or the belt type continuously variable transmission 18 is in the slip state. At next step S4, a fail-safe in case of the slip failure is implemented. Specifically, the output of the engine 12 is limited so as to reduce the input torque input to the forward clutch C1 or the backward brake B1. This leads to the suppression of the slip (including complete engagement) of the forward clutch C1 or the backward brake B1, and the slip of the belt type continuously variable transmission 18 is also suppressed by the reduction in the input torque.

If the judgment at step S2 is NO (negative), i.e., if the input/output rotation speed difference δN is smaller than the slip determination value δNs, it is determined at step S5 that the complete release failure occurs in which the forward clutch C1 or the backward brake B1 is in the complete release state. At next step S6, a fail-safe in case of the complete release failure is implemented. Specifically, since the complete release failure occurs because the relay valve 102 is switched to the first supply position due to a malfunction of the solenoid valve SC etc., and the garage shift oil pressure PG is supplied to the forward clutch C1 or the backward brake B1, the relay valve 102 is switched to the second supply position by the abnormal-time solenoid valve SF to allow the relay valve 102 to output the high-low oil pressure Hi/Lo. As a result, the clutch C1 or the brake B1 is completely engaged by the high-low oil pressure Hi/Lo, enabling the limp-home operation.

As described above, in the vehicle drive device 10 of this example, if a determination of abnormality is made at step S1 to indicate the slip failure in which the forward clutch C1, the backward brake B1, or the belt type continuously variable transmission 18 is in the slip state or the complete release failure in which the forward clutch C1 or the backward brake B1 is in the complete release state, it is judged at step S2 whether the input/output rotation speed difference δN of the torque converter 14 is equal to or greater than the predetermined slip determination value δNs and, it is determined at step S3 that the slip failure occurs in the case of δN≧δNs or it is determined at step S5 that the complete release failure occurs in the case of δN<δNs. As a result, the subsequent fail-safe can individually properly be implemented at step S4 or S6 and the deterioration in limp-home capability etc., due to excess fail-safe can be suppressed.

In this example, since the shift control of the belt type continuously variable transmission 18 is provided based on the turbine rotation speed NT and the target rotation speed Nint on the premise that the forward clutch C1 or the backward brake B1 is in the complete engagement state, a rotation speed sensor detecting the input rotation speed Nin of the belt type continuously variable transmission 18 is not necessary and an inexpensive configuration is achieved. In this case, if the slip state or the complete release state occurs in the forward clutch C1 or the backward brake B1 that should be in the complete engagement state, the shift control of the belt type continuously variable transmission 18 based on the turbine rotation speed NT cannot properly be provided and, therefore, by comparing the turbine rotation speed NT with the target rotation speed Nint, the determination of abnormality can properly be made to indicate that the forward clutch C1 or the backward brake B1 is in the slip state or the complete release state.

In this example, when the determination of abnormality is made at step S1 to indicate that the forward clutch C1 or the backward brake B1 is in the slip state or the complete release state or the belt type continuously variable transmission 18 is in the slip state and when the input/output rotation speed difference δN of the torque converter 14 is equal to or greater than the slip determination value δNs at step S2, the slip failure is distinguished not only when the forward clutch C1 or the backward brake B1 is in the slip state but also when the belt type continuously variable transmission 18 is in the slip state. In other words, since the determination of abnormality is made based on the turbine rotation speed NT and the target rotation speed Nint, a changing trend of the turbine rotation speed NT due to a slip is the same regardless of whether the slip state of the forward clutch C1 or the backward brake B1 or the slip state of the belt type continuously variable transmission 18 and, therefore, not only the complete release failure and the slip failure of the forward clutch C1 or the backward brake B1 but also the slip failure of the belt type continuously variable transmission 18 can be distinguished at the same time.

In this example, the hydraulic control circuit of FIG. 3 is included in relation to the engagement/release control of the forward clutch C1 and the backward brake B1, and the failure of the relay valve 102 switched to the first supply position due to a malfunction of the solenoid valve SC etc., causes the forward clutch C1 or the backward brake B1 to enter the complete release state while the failure of the high-low oil pressure Hi/Lo set to the low pressure Lo due to a malfunction of the solenoid valve SL etc., causes the forward clutch C1 or the backward brake B1 to enter the slip state; however, by executing the signal process in accordance with the flowchart of FIG. 6, the failures causing the forward clutch C1 or the backward brake B1 to enter the complete release state and the slip state are properly distinguished from each other and the fail-safe can individually properly be implemented.

In other words, if it is determined at step S3 that the slip failure occurs, the output of the engine 12 is limited so as to reduce the input torque input to the forward clutch C1 or the backward brake B1 at step S4 and, therefore, the slip of the forward clutch C1 or the backward brake B1 is suppressed while the slip of the belt type continuously variable transmission 18 is also suppressed by the reduction in the input torque, resulting in improved durability thereof. If it is determined at step S5 that the complete release failure occurs, the relay valve 102 is switched to the second supply position by the abnormal-time solenoid valve SF to completely engage the forward clutch Cl or the backward brake B1 by the high-low oil pressure Hi/Lo, thereby enabling the vehicle to run and perform the limp-home operation.

Although the example of the present invention has been described in detail with reference to the drawings, the example merely represents an embodiment and the present invention can be implemented in variously modified and improved forms based on the knowledge of those skilled in the art.

### NOMENCLATURE OF ELEMENTS

10: vehicle drive device 12: engine (power source) 14: torque converter (hydraulic power transmission device) 18: forward/backward switching device 18: belt type continuously variable transmission 50: electronic control device 102: relay valve 110: shift control means 120: abnormality detecting means 122: abnormality distinguishing means Cl: forward clutch (hydraulic friction engagement device) B1: backward brake (hydraulic friction engagement device) NT: turbine rotation speed (input rotation speed of the friction engagement device) Nint: target rotation speed (target gear ratio) δN: input/output rotation speed difference of the torque converter PG: garage shift oil pressure Hi/Lo: high-low oil pressure SLU: linear solenoid valve (hydraulic control valve) SF: abnormal-time solenoid valve

1. A control device of a vehicle drive device in which an output of a power source is input from a hydraulic power transmission device via a friction engagement device to a continuously variable transmission and transmitted toward drive wheels after speed is changed by the continuously variable transmission, the control device comprising:
an abnormality detecting portion configured to make a determination of abnormality indicating that the friction engagement device is in a complete release state or a slip state; and
an abnormality distinguishing portion, if the abnormality detecting portion makes a determination of abnormality, configured to judge that the friction engagement device is in the slip state when an input/output rotation speed difference between an input rotation speed and an output rotation speed of the hydraulic power transmission device is equal to or greater than a predetermined slip determination value and that the friction engagement device is in the complete release state when the input/output rotation speed difference is less than the slip determination value.

2. The control device of a vehicle drive device of claim 1, comprising
a shift control portion configured to detect an input rotation speed of the friction engagement device to provide shift control of the continuously variable transmission based on the input rotation speed and a predetermined target gear ratio on premise that the friction engagement device is in a complete engagement state, wherein
the abnormality detecting portion makes the determination of abnormality based on the input rotation speed and the target gear ratio.

3. The control device of a vehicle drive device of claim 2, wherein
the continuously variable transmission is a belt type continuously variable transmission, wherein
the abnormality detecting portion makes a determination of abnormality indicating that the friction engagement device is in a complete release state or a slip state or that the belt type continuously variable transmission is in a slip state, and wherein
the abnormality distinguishing portion judges that the friction engagement device or the belt type continuously variable transmission is in the slip state if the input/output rotation speed difference of the hydraulic power transmission device is equal to or greater than the slip determination value.

4. The control device of a vehicle drive device of claim 1, wherein
the friction engagement device is a hydraulic friction engagement device engaged by oil pressure, wherein
the control device comprises a relay valve having a first supply position for supplying to the hydraulic friction engagement device a garage shift oil pressure adjusted by a hydraulic control valve and a second supply position for supplying to the hydraulic friction engagement device a high-low oil pressure controlled between two high and low stages depending on a transmission torque, wherein the relay valve is switched to the first supply position when the hydraulic friction engagement device is switched from a release state to an engagement state, wherein the relay valve is switched to the second supply position at the time of complete engagement of the hydraulic friction engagement device, wherein
the hydraulic friction engagement device enters the complete release state due to a failure in which the relay valve is switched to the first supply position at the time of complete engagement of the hydraulic friction engagement device, and wherein the hydraulic friction engagement device enters the slip state due to a failure in which the high-low oil pressure is put into a low pressure state at the time of high pressure.

5. The control device of a vehicle drive device of claim 4, wherein
if the abnormality distinguishing portion judges that the friction engagement device is in the slip state, an input torque input to the hydraulic friction engagement device is reduced, and wherein
if the abnormality distinguishing portion judges that the friction engagement device is in the complete release state, the relay valve is switched to the second supply position by an abnormal-time solenoid valve to completely engage the hydraulic friction engagement device by the high-low oil pressure.
